(19) United States
(12) Patent Application Publication
(10) Pub. No.: US 2012/0278268 A1
(43) Pub. Date: Nov. 1, 2012

(54) METHOD AND APPARATUS FOR EXTRACTING EXPLICIT PROFILE REPRESENTATION THROUGH ADAPTIVE RECOMMENDER SYSTEM

(75) Inventors: Jari Pekka Hämäläinen, Kangasala As (FI); Juha Kalevi Laurila, St-Legier (CH); Olivier Dousse, Lausanne (CH); Sailesh Kumar Sathish, Tampere (FI)

(73) Assignee: Nokia Corporation, Espoo (FI)

(21) Appl. No.: 13/453,354

(22) Filed: Apr. 23, 2012

Related U.S. Application Data
(60) Provisional application No. 61/480,128, filed on Apr. 28, 2011.

(51) Int. Cl. G06F 17/00

(52) U.S. Cl. 706/46

(57) ABSTRACT

An approach is provided for providing recommendations based on preloaded models and for generating user profiles to personalize a user experience with a device or service. A recommendation model platform processes at least one latent user model, at least one latent item model, or a combination thereof associated with a device to determine one or more user preference scores with respect to one or more items. The recommendation platform also processes the one or more user preference scores against one or more thresholds values to determine explicit preference information associated with the one or more items. The recommendation platform also generates at least one user profile associated with the device, a user of the device, or a combination thereof based, at least in part, on the explicit preference information.

### RELATED APPLICATIONS

This application claims the benefit of the earlier filing date under 35 U.S.C. §119(e) of U.S. Provisional Application Ser. No. 61/480,128 filed Apr. 28, 2011, entitled “Method and Apparatus for Extracting Explicit Profile Representation Through Adaptive Recommender System,” the entirety of which is incorporated herein by reference.

### BACKGROUND

Service providers and device manufacturers (e.g., wireless, cellular, etc.) are continually challenged to deliver value and convenience to consumers by, for example, providing compelling network services. One area of interest has been configuring a device according to user's characteristics, such as user preferences and/or user behavior. Approaches have been developed to enable customization of a user device and applications in the user device according to user's preferences, by configuring settings for the user device and/or the applications. For example, users can manually customize ringing tones for different applications, alert, volumes for different operations, etc. Further, users may provide data regarding user's tendency in using the user device or the applications, such that the user device and/or the applications may be configured automatically based on the collected data. For example, a music application may maintain a record of frequencies of music files played using the music application, and may customize the music application according to the record. However, conventional approaches for personalizing the device and/or applications are often limited in scope and may need to involve external devices or services other than the device itself. Therefore, a convenient and safe way to utilize the collected data to provide automatic personalization for a device is desired. Further, it is desirable to generate an explicit user profile based on the automatic personalization and other latent factors that may be sent to a service provider for personalizing a service that is available based on the automatic personalization of the device.

### SOME EXAMPLE EMBODIMENTS

Therefore, there is a need for an approach for providing recommendations based on pre-loaded models, collaborative/evolving models, and for generating a user profile that may be used to personalize an external service experience.

According to one embodiment, a method comprises processing and/or facilitating a processing of at least one latent user model, at least one latent item model, or a combination thereof associated with a device to determine one or more user preference scores with respect to one or more items. The method also comprises processing and/or facilitating a processing of the one or more user preference scores against one or more thresholds values to determine explicit preference information associated with the one or more items. The method further comprises causing, at least in part, a generation of at least one user profile associated with the device, a user of the device, or a combination thereof based, at least in part, on the explicit preference information.

According to another embodiment, an apparatus comprises at least one processor, and at least one memory including computer program code, the at least one memory and the computer program code configured to, with the at least one processor, cause, at least in part, the apparatus to process and/or facilitate a processing of at least one latent user model, at least one latent item model, or a combination thereof associated with a device to determine one or more user preference scores with respect to one or more items. The apparatus is further caused to process and/or facilitate a processing of the one or more user preference scores against one or more thresholds values to determine explicit preference information associated with the one or more items. The apparatus is also caused to cause, at least in part, a generation of at least one user profile associated with the device, a user of the device, or a combination thereof based, at least in part, on the explicit preference information.

According to another embodiment, a computer-readable storage medium carries one or more sequences of one or more instructions which, when executed by one or more processors, cause, at least in part, an apparatus to process and/or facilitate a processing at least one latent user model, at least one latent item model, or a combination thereof associated with a device to determine one or more user preference scores with respect to one or more items. The apparatus is further caused to process and/or facilitate a processing of the one or more user preference scores against one or more thresholds values to determine explicit preference information associated with the one or more items. The apparatus is also caused to cause, at least in part, a generation of at least one user profile associated with the device, a user of the device, or a combination thereof based, at least in part, on the explicit preference information.

According to another embodiment, an apparatus comprises means for processing and/or facilitating a processing of at least one latent user model, at least one latent item model, or a combination thereof associated with a device to determine one or more user preference scores with respect to one or more items. The apparatus also comprises means for processing and/or facilitating a processing of the one or more user preference scores against one or more thresholds values to determine explicit preference information associated with the one or more items. The apparatus further comprises means for causing, at least in part, a generation of at least one user profile associated with the device, a user of the device, or a combination thereof based, at least in part, on the explicit preference information.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: an apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing recommendations based on preloaded models, according to one embodiment;

FIG. 2 is a diagram of the components of the model platform, according to one embodiment;

FIG. 3 is a diagram of the components of the model platform, according to one embodiment;

FIGS. 4A-4D are flowcharts of processes for generating a user profile and/or any recommendations, according to one embodiment;

FIG. 5 is a diagram of interactions utilized in the processes of FIGS. 4A-4D, according to one embodiment;

FIG. 6 is a diagram of a user device having personalized settings, according to one embodiment;

FIG. 7 is a diagram of interactions utilized in the processes of FIGS. 4A-4D, according to one embodiment;

FIGS. 8A-8B are diagrams of user interfaces of an unknown user and a known user, respectively, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing recommendations based on preloaded models and for generating user profiles are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

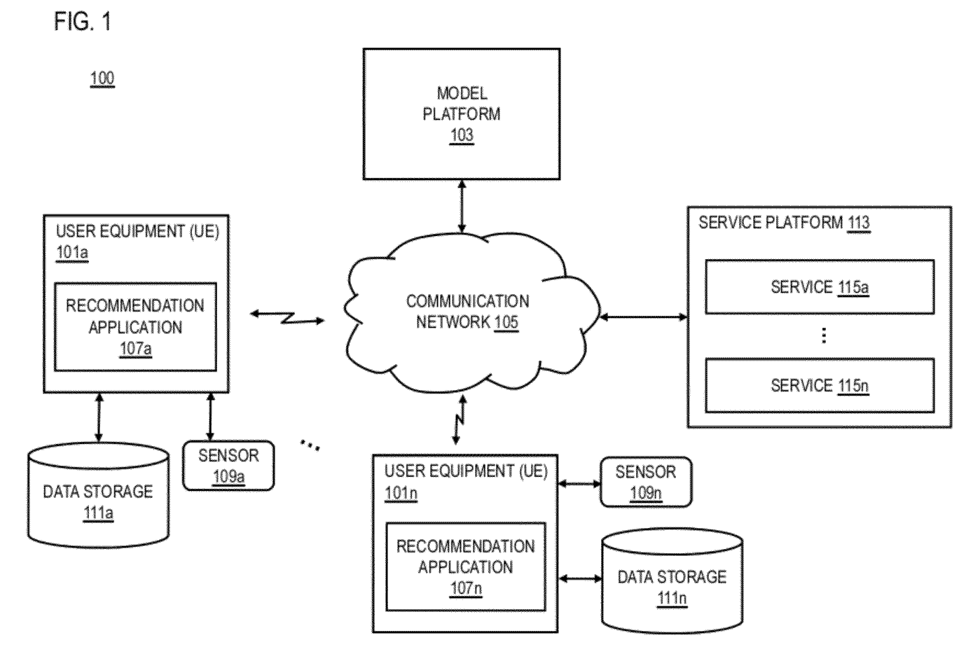

FIG. 1 is a diagram of a system capable of providing recommendations based on preloaded models and for generating user profiles, according to one embodiment. As previously discussed, personalization for a device and/or applications in the device according to the user has not been easily attained, although simple personalization may be performed. In particular, when there are many different users using the same application or the same type of applications, the applications cannot be personalized to the different users. In other words, user experience for a software application is generally the same for all users using their own respective devices, and the software application is not personalized for each user unless the user changes the settings for the application manually. There have been services provided for devices such that the services mine data from the devices and perform personalization based on the mined data for each of the devices. However, this may cause the services to mine personal data from a user's device that the user considers private or secret. Therefore, some users may not utilize this personalization approach by the services for privacy reasons. Further, because the data needs to be transmitted to an entity outside of the user's device, the user's device may need more resources in network connection and may also drain more power or battery in the user's device. Therefore, a convenient approach to provide user personalization for the device and/or the device's applications while minimizing transmission of private user data to another device or a service is desired.

As WAP-enabled devices come of age, an assumption of device homogeneity is no longer valid. In particular, mobile devices can be expected to have an increasingly divergent range of input and output capabilities, network connectivity, and levels of language support. Moreover, user may have content presentation preferences that also cannot be transferred to a server for consideration. As a result of this device heterogeneity, and the limited ability of users to convey their content presentation preferences to a server, clients may receive content that they cannot store, that they cannot display, that violates the desires of the user, or that takes too long to convey over the network to the content device.

Work is ongoing in the World-Wide Web Consortium (W3C) to define mechanisms for describing and transmitting information about the capabilities of Web clients and the display preferences of Web users. The Composite Capabilities/Preferences Profile (CC/PP) specification [CCPP] defines a high level structured framework for describing this information using Resource Description Framework (RDF). CC/PP profiles are structured as named “components,” each containing a collection of attribute-value pairs, or properties. Each component may optionally provide a default description block containing either a set of default values for attributes of that component or a Uniform Resource Identifier (URI) that refers to a document containing those default values. Any attributes explicitly provided in the component description therefore override the default values provided in the default description block or through that URI. The CC/PP specification does not mandate a particular set of components or attributes, choosing instead to defer that definition to other standards bodies. The mechanism by which the profile is transported between the mobile terminal, WAP Gateway and origin server is defined in this specification.

The User Agent Profile (UAProf) specification extends WAP 2.0 to enable the end-to-end flow of a UAProf, also referred to as Capability and Preference Information (CPI), between the WAP client, the intermediate network points (proxies and gateways), and the origin server. It seeks to interoperate with the emerging standards for CC/PP distribution over the Internet. It uses the CC/PP model to define a robust, extensible framework for describing and transmitting CPI about the client, user, and network that will be processing the content contain in a WSP/HTTP response. The specification defines a set of components and attributes that WAP-enabled devices may convey within the CPI. This CPI may include, but is not limited to:
Hardware characteristics (screen size, color capabilities, image capabilities, manufacturer, etc.)
Software characteristics (operating system vendor and version, support for MexE, list of audio and video encoders, etc.)
Application and user preferences (browser manufacturer and version, markup languages and versions supported, scripting languages supported, etc.)
WAP characteristics (WML script libraries, WAP version, WML deck size, etc.) and
Network characteristics (bearer characteristics such as latency and reliability, etc.).

The specification seeks to minimize wireless bandwidth consumption by using a binary encoding for the CPI and by supporting efficient transmission and caching over WSP in a manner that allows easy interoperability with HTTP.

As a request travels over the network from the client device to the origin server, each network element may optionally add additional profile information to the transmitted CPI. These additions may provide information available solely to that particular network element. Alternatively, this information may override the capabilities exposed by the client, particularly in cases where that network element is capable of performing in-band content transformation to meet the capability requirements of the requesting client device.

If an MMS Client performs capability negotiations then it must use a mechanism specified in UAProf. The MMS Proxy Relay should support this mechanism.

If using capability negation, the MMS Client shall indicate with capabilities within the UAProf information by using attributes from the MMS Characteristics component defined below and optionally by using attributes from other components of the UAProf schema. The MMS Proxy-Relay may use this information in preparation of messages to be delivered to the MMS Client.

The MMS Proxy-Relay may adjust an MM to be delivered that contains media types that are not supported by the MMS client. This adjustment may involve the deletion or adaptation of those unsupported media types.

The UAProf specification includes a schema containing attributes that describe the client hardware, the browser user-agent, network characteristics and more. Some of the attributes included in the aforementioned specification also apply to the MMS Client, e.g. “ScreenSize,” “CPUTYPE,” and “PushMessageSize.”

A system 100 of FIG. 1 introduces the capability to provide recommendations based on preloaded models and generate a user profile that may be used to personalize a device experience and/or an external service experience. According to one embodiment, the system 100 determines to cause preloading of a device (e.g. UE 101) with a user model and/or an item model. A user model includes information about the user's behavior, specificities, data captured by the user's device, etc. The item model may be computed based on collected data corresponding to various items related to the user or the user's device. In this case, the items may represent various features or settings such as user interface modes, points of interest, etc. After preloading the device with the user model and/or the item model, the system 100 determines to cause processing of the user model and/or the item model to generate recommendations for the device and/or the user of the device. The recommendations may include recommendations of various features in the device. The features to be recommended may be items that include user interface modes, tips and points of interests, for example. The system 100 may also refine the user model based on user behavior and user interaction with applications available through the device over time. The device may include various user interface modes having different features and/or designs, and the recommendations may be made for a suitable user interface based on the user model and/or the item model. The device may also include a library of tips (e.g. hints, tricks, etc.) in using the device and/or applications in the device, and the tips may be presented based on the recommendations. Further, if the device contains a map, the recommendations may be made for points of interest based on the user model and/or the item model.

In one sample use case, a user study is performed first to collect data that is used to generate user models and item models that can be preloaded to the user's device. This process to compute the user model may be performed on a plurality of devices that have been volunteered to become test devices. The test devices may collect various types of data regarding the test devices and/or the test user of the test devices. For example, the types of data may include data from sensors connected to the device, data on usage of the device (internal device usage monitoring), data on usage of external services by the device, the device's interaction with other devices and/or other services that are external to the device, etc. Sensor based gathering may involve, e.g., location (GPS, WIFI, cell ID based positioning), accelerometer, gyroscope, compass, audio monitoring, activity detection (i.e. walking, running, driving a car, eating, sitting on a train, being at a meeting, staying at home, staying at the office, etc.). Internal device usage monitoring may monitor, e.g., which applications are used (e.g. calls, text messages, email, calendar, music listened, advertisements clicked, settings made to personalize the phone), when and where they are used, and how they are used. External service usage may monitor e.g. which Internet services are used (Pictures loaded and seen through internet service Flicker, music songs bought, YouTube videos watched, items bought from online store), when and where they are used, and how they are used. Such data collection gathers large amounts of usage data, which consumes radio interface capacity, battery, and also may cost much for the user. Therefore, it is preferable to limit such an extensive data gathering only to a limited user study rather than applying it in global scale for all the consumers.

Each individual device participating in the user study gathers the above mentioned data and delivers that data to network servers. Thus a service gets plenty of data from various kinds of users. This data may be sent to a module or a platform that exists in a service or at least one of the devices. This data regarding the device and/or the user of the device is processed by a user model generation engine in the module to generate series of quantitative values associated with the information, wherein the quantitative values are passed to a function that returns a user model. The user model may be a vector, and a size of this vector may be n. This vector may include some or all of information of the quantitative values. Also, during the user study, the data regarding ratings on items may be collected. The items may represent features or characteristics of the user's device and/or the user, and may be included in the various types of the data collected in the test devices. For example, if an item is a tip on using the user's device, for each tip, the test user may place a rating. Then, the ratings data for this item is collected. Thus, each test user may have a series of ratings depending on the items.

A conversion engine converts mobile phone usage and sensory data into the so-called user profile vector (UPV) that summarizes the specificities of the user of the mobile phone. This UPV is computed locally on the mobile phone, or external to the device, using the data available in the device and the computing power of the device. The purpose of the UPV is to compute a score for a number of items that can be offered to the user. The score reflects the suitability of an item for the user. The idea is to expose the items with the highest score to the user, thus offering a well-personalized experience. Items can be for instance: (1) user interface modes, i.e., if the phone offers several modes of operation of its user interface, the mode with the highest score is selected automatically, (2) tips, i.e., if the phone comes with a library of hints and tricks, these are revealed to the user by decreasing order of score, (3) points of interest, i.e., if the phone contains maps with points of interest (POIs), the POIs with the highest score in the current map view are highlighted, etc.

Using the user model and the user/item rating matrix, which represents the ratings data for the items, an item model may be computed.

This item model computed based on the user model and the ratings data may be preloaded to the user device, along with the user model generation engine. For example, during manufacturing of the user device, the item model and the user model generation engine may be preloaded to the user device. After a user first purchases the user device, during the first few days of use, the user device may collect various types of data regarding the device and/or the user of the user device, and compute the user's user model based on the collected data, using the user model generation engine. Then, based on the preloaded item model and the computed user's user model, ratings of the items may be estimated. The ratings of the items may be used to generate recommendations of the items. For example, if the ratings of the user interface indicate that a business user interface has the highest rating and a tourist user interface has a lower rating, the business user interface may be recommended.

To realize this goal, the following steps are needed:
A user study: a number of volunteers are running the UPV calculation engine on their mobile phone and reveal their profile vector to the manufacturer. They are requested to assess items with a (subjective) grade. For some items the grade can be computed implicitly by recording the usage of the item.
An item profile vector (IPV) is computed for each item based on the user study. The IPV is done such that the combination of a UPV and an IPV results in a score that mimics the subjective grades given by the test users.
The items and their IPV, as well as the UPV calculation engine along with the UPV's computed with the test users, is pre-loaded to the phones.
The device will initially use preloaded UPV's and the IPV's to provide recommendations till the device user specific UPV is computed. As the user start using the phone, his UPV is computed. This allows, e.g., using the pre-loaded IPV's to compute scores for each items.
As more usage and sensor data is available on the phone, the calculation of the UPV is refined.

The UPV and IPV form a full recommendation model (pre-loaded model). The UPV is a general model that depicts general user behavior but not necessarily the user on whose device the model gets loaded.

The item model is reflected within the IPV. What the items are and what types of ratings/interactions have been used to build each type of model would depend on the application front. Even though there may not be a need to identify the specific user whose behavior factor is reflected in UPV, the items within the IPV needs to be identified. Each column within the IPV reflects a particular item. The item model will be associated with item ontology.

Using the ontology, the particular item can be identified, and characteristics of the item described. In some embodiments, this can be a simple registry or a combination of a registry describing the items (using any standard description methods such as XML description) and an ontology that provides more item characteristics, or for certain items only. The characteristics may describe threshold levels for latent values within the UPV corresponding to items within the IPV where behaviors are described for a particular range of values, conditional probability for other items that may be invoked in case of certain values etc. Item models may have an associated ontology. The ontology describes the type of items rated within the model, the characteristics of each type or group of items, possible name spacing of certain item names, an optional number of each type of items, boundary definitions for each group of items (i.e., how many of a particular item is there), ratings or interaction type for the model, rating types for each item within the model, interpretation of values for each item within the model, boundary range of values for each item within the model and inference within each boundary, dependencies to other items, if the calendar shows an ongoing meeting, the user probably does not answer the phone calls, dependencies to context values and boundary range for values for each item within model, applications typically used while at the office, home, or typical actions while driving in a car or in a meeting, conditional probability levels between items (e.g., the persons who the user normally calls while some other persons they normally send text message), etc.

Models may be built with different types, but may be united through a single “ratings” or “interaction” pattern. Collaborative models (such as Matrix Factorization) are built where a single type of rating or single interaction model is used. Each model built may have different types of items, for example, a music rating (track—good or bad), an application type (preferred, non-preferred), calendar view (on/off) etc. for a binary ratings model. There would be other models which can take a range of values, for example a rating from one star to five stars.

Several models may, therefore, be built and each model would have an associated ontology describing the items there. Alternatively, a single ontology may be provided that would contain sections for each model (keeping common data the same) while the differences (deltas) may be provided through an “id” field that describes which model it is referring to.

The set of models and the ontology (ontologies) forms a pre-installable package on the user device. Every new user device may be flashed with this package from the software factory before becoming available to users. The ontologies may also be updated from time to time either through a single network based service or through a multitude of services updating specific sections of the ontology (ontologies).

Some items within the model may be simple numerical values depicting latent factors. Some embodiments of the framework described would simply map the values to a binary “yes” or “no” (1 or 0) if the value falls or below a threshold as interpreted by the embodiment.

The pre-installed UPV is used to derive a user behavior model based on user interaction that happens within the device. Once a mature user model (latent model) is derived within the device, a static descriptive profile may be derived for the user based on user model derived, IPV, item ontology, profile rules and templates.

Once a latent user behavior model is built, that model may be used to build a descriptive semi-dynamic profile that can be exported to other services. This representation could be XML based and any standard industry representation of user profile can be utilized even though certain extensions may be necessary to incorporate more powerful features that can be derived from it. The user profile (structured representation) may provide: items preferred by user, application data used by user, context under which items were used, conditional item recommendations based on other items, conditional item recommendations based on data within other items, conditional data within an item based on other items, conditional data within an item based on data within other items, top n recommendations given a particular item or group of items as input, probability factor of each recommendation within top n recommendation towards each item, etc.

For providing user preference information and user profile information to external services, a latent model does not make any sense. This is particularly true for web based applications that rely on explicitly defined content representations for performing application and content adaptation. For web applications, even for in-device adaptation, an explicit representation is needed. External services may, therefore, request the user profile through an interface and the user profile can be extended to browser applications through a browser extension. In certain embodiments, this explicit user profile may be reconverted back to latent representation via use of the profile and ontology.

In generating the user profile, one or more user preference scores may be determined; and ratings about particular functions or preferences, for example, and threshold values may be assigned for particular functions. If a score meets a threshold value, preference information may be determined to be designated as explicit and may be used to generate the user profile. As discussed above, the user profile, may be sent to one or more external services to enable those services to apply the preferences and/or any recommendations that may be made based on the information available in the explicit user profile. In one embodiment, the user profile includes an explicit representation schema for indicating user preferences with respect to, for instance, one or more items or concepts expressed in the profile. For example, the schema may specify terms, names, identifiers, etc. for representing the items or concepts and/or the relationships among the items or concepts according to an item ontology. Accordingly, when applying the explicit user profile to one or more external services, a translator may be used to apply the preferences expressed in the schema of the user profile to the items that are specific to the one or more external services. In some embodiments, the translator includes, at least in part, another ontology that provides mapping information between the item ontologies of the external services to the items and/or concepts in the explicit representation schema of the user profile.

In various embodiments, the security and access model may be defined separately and controlled through a preferences access interface to the user profile. A user may set access and security preferences to restrict or allow particular service to have access to the user's user profile or to allow the user's explicit user profile to be sent to external services for processing. The user may also set an allowable detail of ontology information to be accessible so that a granularity of the ontology may be determined based on the user's specified privacy policy. Also, by way of the preferences access interface, a user may set preferences for how often the user profile is updated. The user profile may be updated, for example, periodically, according to a schedule, on demand, or any combination thereof.

As shown in FIG. 1, the system 100 comprises a user equipment (UE) 101 having connectivity to a model platform 103 via a communication network 105. Further, the UEs 101a-101n may have connectivity to one another via a communication network 105. The model platform 103 may be used to process a user model and/or an item model to generate recommendations for a device (e.g. UE 101) and/or a user of the device. The model platform 103 may also process a collection of data to generate the user model and/or the item model. The model platform 103 may exist in the UE 101 or in the service or independently. The UE 101 may include a recommendation application 107 (e.g., recommendation applications 107a-107n) that generates recommendations for the UE 101 based on a user model and/or an item model and/or any other information. The recommendation application 107 may also include a user model generation engine that is used to generate a user model based on the collected data. The UE 101 (e.g., UEs 101a-101n) may also be connected to the data storage connected to a sensor 109 (e.g., sensors 109a-109n), which is used to collect various types of sensor data for storage in, for instance, the data storage 111 (e.g., data storage 111a-111n). The sensor may include a location sensor such as a global positioning system (GPS) device, a sound sensor, a speed sensor, a brightness sensor, etc. The model platform 103 or the UE 101 itself may determine to cause collection of various types of data. The collected data may be related to items, a user of the UE 101, other users of other devices, or a combination thereof. The UE 101 may also have connectivity to a service platform 113 via the communication network 105. The service platform 113 may include one or more services 115a-115n. The services 115a-115n may be websites providing various services to the UE 101. Examples of the services 115a-115n may include a social networking service, an internet shopping service, a digital media service, etc.

The model platform 103 may process the collection of the data collected at the UE 101 in order to generate a user model, an item model, and/or a user profile. The collected data may include user interaction data, ratings data, context data, or a combination thereof. The user interaction data includes data about how the user interacts with the UE 101. The user interaction data may also include the user's interaction with another device or external services such as the services 115a-115n. The ratings data may include user ratings of the items indicating how much the user likes the items (e.g. collected via like/dislike buttons for corresponding items). The context data may include the sensor data, user profile information, a user schedule, etc. Further, the user model may be a user profile vector and the item model may be an item profile vector. Thus, the user model and the item model may have quantitative values. When generating the user model and/or the item model, available data may be quantified to create the user profile vector and the item profile vector. Then, the generation of the recommendation is based on the user profile vector and/or the item profile vector which may be exported to external services 115a-115n as a generated user profile so that when a user goes to the services 115a-115n, the user's preferences may be applied and recommendations may be made to the user, based on information that is in the user profile.

In one embodiment, the system 100 may process the collection of the data prior to the preloading of the device with the user model and/or the item model. Further, in another embodiment, the collection of the data related to the other users may be processed to generate the user model and/or the item model, wherein the other users may represent prototypical users. These prototypical users may be test users that provide collections of data to generate test user models and/or test item models during a user study process. For example, a large number of test users may provide a large collection of data, such that the test user models and/or the test item models can be computed based on the collection of data. These test user models and/or test item models obtained during the user study process may be used to generate recommendations based on the data collected at the user device.

For example, prior to the preloading, the system 100 may collect the data from the devices of the users who have volunteered to be test users. The collected data from the test user devices may be processed to generate a user model having quantitative values, using a user model generation engine. As explained above, the collected data may include the user interaction data, the ratings data, the context data, etc. The user ratings data may be collected during this process by requesting the volunteers to assess the items with ratings such as a grade or a preference for the item. For example, one of the test users may assign 5 out of 10 rating for a business user interface and 2 out of 10 rating for a tourist user interface. As another example, one test user may indicate “like” rating for a tip on how to customize a calendar, and “dislike” rating for a tip on how to shut down the device. A combination of the user model and the item model for each item may result in a score that is related to the rating data. All the user's rating against the items are then used to build the recommendation model. The model built (using factorization methods) is a user vs. item matrix where each row corresponds to a particular test user who volunteered for data collection.

In one embodiment where the user model is not preloaded at the UE 101, the system 100 determines user interaction data, ratings data, context data, or a combination thereof associated with the device and/or the at least one user of the device, and then processes this data to generate the user model. Thus, the UE 101 may generate the user model based on the data collected at the UE 101, if the user model is not preloaded at the UE 101. The collected data at the UE 101 can be processed to generate a user model for the UE 101 using the user generation engine.

In an embodiment where the user model is preloaded at the UE 101, the system 100 determines user interaction data, ratings data, context data, or a combination thereof associated with the device and/or the at least one user of the device, and then processes this data to customize the at least one user model. For example, if the test user model is preloaded at the UE 101, the test user model may be customized based on the collected data at the UE 101 such that this user model can reflect the UE 101 or the user of the UE 101 more closely. In more detail, in this embodiment, a plurality of user models may be formed based on the data collected from a number of test users. Then, a plurality of user model-item model combinations may be formed. Each combination has different characteristics. When the device is preloaded with the user model and/or the item model during the manufacturing phase, the device may be preloaded with a set of the user models. As the user starts using the device, a random user model from the set may be selected. In one embodiment, a corresponding item model is also used. The selected user model and item model are first used to provide recommendations. Then, over a period of time, user feedback is monitored to dynamically build an evolving user model for the user of the device. This evolved user model may be used to select a user model-item model combination from the set of user models, such that the newly selected user model is closer to the evolved user model than the initially selected. This process may continue and may be performed periodically to select a user model that matches closely with the user.

Also, in one embodiment, the system 100 may cause a transfer of the user model and/or the item model from one device to another device or service associated with the user by generating and sharing a user profile. For example, if the user using the UE 101a wants to start using the UE 101b, then the user may transfer the user model and/or the item model from the UE 101a to the UE 101b, such that the user model and/or the item model from the previous device UE 101a can be continued to be utilized in the new device UE 101b. In one embodiment, this transfer may be performed via an external service. For example, the UE 101a may transfer the user model and/or the item model to one of the services 115a-115n via the communication network 105, and the UE 101b may retrieve the transferred user model and/or item model from the one of the services 115a-115n.

Further, in one embodiment, the system 100 determines a new application, a new capability, a new item, new context data, or a combination thereof associated with the device and/or the user. Then, the system 100 causes an update to the user model, the item model, and/or the user profile, based on the new application, the new capability, the new item, the new context data, or a combination thereof. For example, if the UE 101 downloads new items or a new application having new items, then the user model and/or the item model is updated based on the new items or the new application. In addition, the system 100 may cause an update to the user model, the item model, and/or the user profile periodically, according to a schedule, on demand, or a combination thereof. This feature enables maintaining the user model and/or the item model that is up to date.

Therefore, an advantage of this approach is that by providing recommendations for the items while maintaining the user's data within the user device, it provides increased protection of privacy as well as conservation of resources in the user device. Because the user's data may be personal data, the user may want to keep the data within the user's device for protecting privacy. Because this approach preloads the user's device with a user model and/or an item model, the user does not need to transfer the user's data on usage and context data to a service, in order to obtain recommendations for the items, but the user may do so by way of sharing a generated user profile. Further, because the data does not need to be transferred to the service to receive recommendations, the resources for transferring data are conserved.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof. It is contemplated that the communication network 105 may be operated in network mode (e.g., using traditional server-client architecture) or in ad-hoc mode (e.g., direct peer-to-peer connection of participating UEs 101).

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101 and the model platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

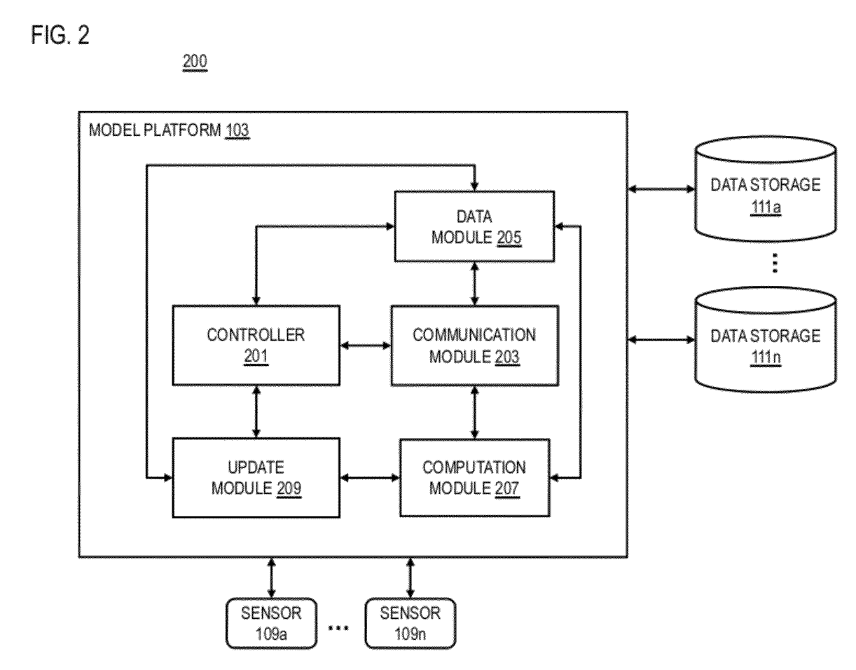

FIG. 2 is a diagram 200 of the components of a model platform 103, according to one embodiment. By way of example, the model platform 103 includes one or more components for providing recommendations based on preloaded models. It is contemplated that the functions of these components may be combined in one or more components or performed by other components of equivalent functionality. In this embodiment, the model platform 103 includes a controller 201, a communication module 203, a data module 205, a computation module 207 and an update module 209. The controller 201 oversees tasks, including tasks performed by the communication module 203, the data module 205, the computation module 207 and the update module 209. The communication module 203 is used for communication between the model platform 103 and one or more of the UE 101 and the service platform 113. The communication module 203 may be used to communicate commands, requests, data, etc. For example, the communication module 203 may be used to cause preloading of the device (e.g. UE 101) with a user model and/or an item model. The communication module 203 may also cause collection of the data. The data module 205 manages the collected data. The data module 205 may also communicate with the communication module 203 to receive and manage of collection of the data. The computation module 207 handles various analysis, estimations, computations, etc. For example, the computation module 207 may perform processing to generate recommendations for the device and/or the user of the device. The computation module 207 may also process the collection of data. The update module 209 may be used to determine updates to user model and/or the item model, and may also be used for any other tasks related to the updates to the device and/or the user of the device.

In one embodiment, the data module 205 may communicate with the communication module 203 to cause preloading of the device (e.g. UE 101) with the user model and/or the item model. Then, the computation module 207 may process or cause processing of the user model and the item model preloaded at the device, or latent factors or preferences set by the user to generate recommendations for the device and/or the user of the device based on an explicit representation of the latent factors. The generation of the recommendation may be performed by the recommendation application 107 of the UE 101 and/or by the computation module 207. The recommendation may include recommendation of items.

The data module 205 may cause collection of data including user interaction data, ratings data, context data, or a combination thereof, wherein this data is related to items, a user of the device, other users, or a combination thereof. For example, the data module 205 may cause one or more of the UEs 101a-101n to collect the data. The user interaction data may include data about the user's interaction within the user device (internal usage) as well as data about the user's interaction with external devices or services (external usage). The ratings data may include ratings assigned for the items. For example, a user may be requested to provide ratings for the items, and the user's ratings of the items may be maintained as the ratings data. The context data may include sensor data collected from a sensor such as a location sensor, speed sensor, sound sensor, etc., as well as a calendar, user profile information and etc. The computation module 207 processes this collection to generate the user model and/or the item model.

The user model may be generated by a user model generation engine in the computation module 207, based on the collected data. The user model generation engine is capable of converting the collected data into a user model having quantitative values for the corresponding items. For example, the user model generation engine may be able to extract quantitative data such as the frequency of usage of each software application, the frequency of the user visiting a library (measured by the location sensor), a frequency of the user visiting the social networking website, etc. based on the collected data, and then generate the user model based on the quantitative data. Thus, the user model represents specificities of the user of the device with respect to the items that the user interacted with. The user data may be combined with the item data to generate user-item model that is based on the ratings data. The user model may be a user profile vector (UPV) and the item model may be an item profile vector (IPV), wherein the generation of the recommendation is based on the user profile vector and/or the item profile vector. Then, a function of the UPV and the IPV, f(UPV, IPV), may generate a real number, which is associated with the user interaction (for example, ratings).

In one embodiment, the processing of this collection is performed prior to the preloading of the device with the user model and/or the item model. For example, the data may be collected from one or more of the UEs 101a-101n, and then may be processed to generate the user model and/or the item model. Then, the generated user model and/or the item model may be preloaded at the user device (e.g. one of the UEs 101a-101n). In another embodiment, the other users represent prototypical users. The prototypical users may be test users during a user study process to determine a test user model and a test item model. For example, a number of users may volunteer as the test users, and may agree to provide the data collected at their devices, wherein the data may include the user interaction data, ratings data, context data, or a combination thereof. The computation module 207 may process this data from the devices of the test users to generate the user model and the item model. As explained above, the user model and the item model may be the UPV and the IPV, respectively. In one example, in order to compute for an IPV for each item, the following objective function may be used according to a mean square error approach:

$${\sum }_{users} {( UPV \cdot IPV - Rating )}^{2} , \qquad ( 1 )$$

where f(UPV, IPV) is a dot product of the UPV and the IPV. The IPV is computed such that the equation (1) may produce the lowest possible number for the given UPV and the rating.

A user model may be preloaded in the user device along with the item model associated with the user model. In this embodiment, the device may determine its own data including interaction data, ratings data, context data, or a combination thereof, and then process this data to customize the user model. For example, a plurality of user models may be created based on the data collected from the test users, as well as item models associated with the user models. The device is first preloaded with a randomly selected user model and its associated item model. Over a period of time, the device may capture the data and process the data to dynamically evolve the user model to generate a user profile. The evolved user model may then be compared with the plurality of the user models, and a new user model that matches the evolved user model may be selected and loaded at the device, along with its associated item model. This process may be repeated to continuously update the user model according to the data, in order to reflect a user profile of the user.

Further, the update module 209 may determine a new application, a new capability, a new item, new context data, or a combination thereof associated with the device and/or the user. For example, a new application may be downloaded to the device, and this new application may have new items and/or enable acquisition of new context data, or a new update for the device may be provided to the device such that the device has a new capability. Then, the update module 209 may cause update to the user model and/or the item model based on the new application, the new capability, the new item, the new context data, or the combination thereof. The update to the models is done through a re-computation of the latent factors used to model both user and item model via the model generation module. In addition, the update module 209 may cause update to the user model and/or the item model periodically (e.g. weekly, monthly, etc.), according to a schedule, on demand, or a combination thereof

In addition, a user may want to switch from one device to another device, but wants to maintain the user model, the item model, and/or the user profile. The communication module 203 may cause a transfer of the user model and/or the item model from the first device to the second device associated with the user. This transfer may also be performed via, or to, an external service. For example, the communication module 203 may cause a transfer of the user model, the item model, and/or the user profile from the first device to an external service. Then, the user model, the item model, and/or the user profile in the external service can be downloaded to the second device, and/or to the service itself for personalizing a user experience of the service.

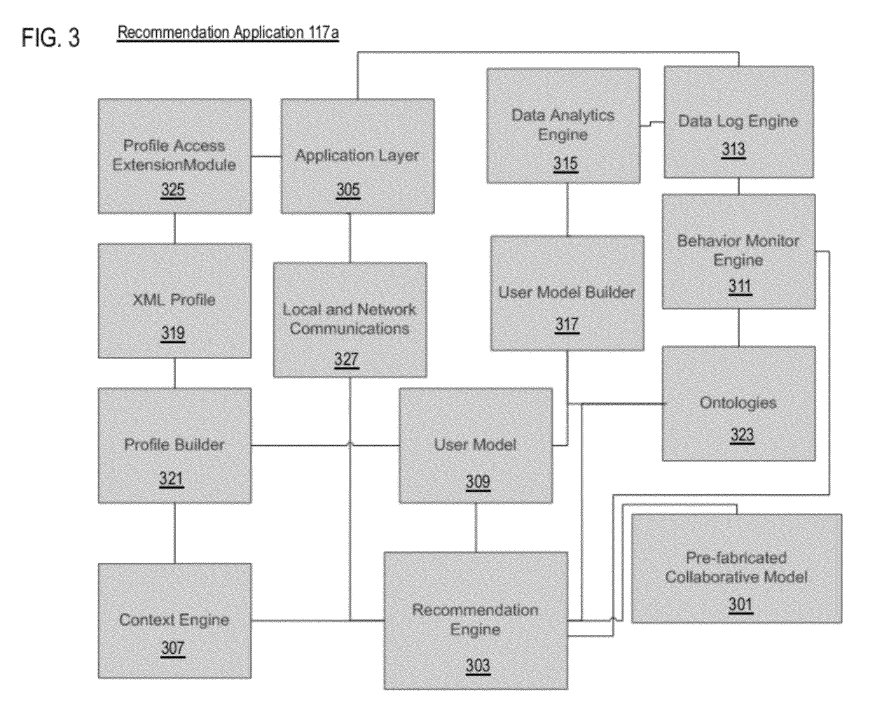

FIG. 3 diagram of the components of the model platform 103, according to one embodiment. By way of example, the model platform 103, in this embodiment, includes one or more components for providing recommendations based on preloaded models and for generating a user profile. It is contemplated that the functions of these components may be combined in one or more components or performed by other components of equivalent functionality. In this embodiment, the model platform 103 includes a pre-fabricated collaborative model 301, a recommendation engine 303, an application layer module 305, a context engine 307, a user model 309, a behavior monitor engine 311, a data log engine 313, a data analytics engine 315, a user model builder 317, an XML profile module 319, a profile builder 321, a profile access extension module 325 and local and network communications module 327.

The pre-fabricated collaborative model 301 as mentioned earlier comes pre-installed on device. The ontologies describe the concepts behind the pre-fabricated collaborative model 301. The recommendation engine 303 uses the pre-fabricated collaborative model 301 to make initial recommendations to application layer module 305. The initial recommendations may be performed by recommendation engine 303 taking data from context engine 307 and performing searches within pre-fabricated collaborative model 301 to find an appropriate user model module 309. Based on user model module 309 data within pre-fabricated collaborative model 301, the recommendation engine 303 recommends behavior to application layer module 305.

The behavior monitor engine 311 monitors user behavior through the data log engine 313 and provides continuous feedback to recommendation engine 303 which is then used to refine search of the user model module 309 within the pre-fabricated collaborative model 301. Simultaneously, the data analytics engine 315 with the user model builder 317 builds the local user model module 309. The local user model module 309 represents the actual user behavior that may be different from the user model module 309's contained within the pre-fabricated collaborative model 301. The recommendation engine 303 can consult either the local user model module 309 or the behavior monitor engine 311 to make adequate selections of user model module 309's from the pre-fabricated collaborative model 301. This is done only till the user model module 309 reaches a certain maturity level, e.g., the data log engine 313 logs enough interaction or rating data to get local user model module 309 to a pre-defined maturity level. The feedback used by recommendation engine 303 from either the local user model module 309 or behavior monitor engine 311 is implementation dependent.

The framework builds an explicit profile that defines user behavior explicitly, such as an XML representation by way of the XML profile module 319. There could be an internal dynamic representation such as representation of profile as a hierarchical tree structure (non-normative). Explicit representations are needed for external applications where latent models do not make any sense. The representation could thus be a serialized form of internal structure like the XML representation mentioned. The profile builder 321 utilizes data from user model module 309 (local) along with possible context information to build the model. The profile builder 321 may use its own ontology which may be acquired via ontology module 313 and templates to capture data for the profile. In other words, the user profile is constructed according to an explicit representation schema based, at least in part, on an ontology that defines how the XML profile module 319 represents items or concepts and their relationships in the profile. In addition, a profile access extension module 325 may be provided for access for local applications to the profile. Applications such as browser scripts would need access to explicit representations to make either in-device or network based adaptations based on behavior model and context. As context is directly used from device, the profile is able to capture behavior, system and environmental characteristics explicitly. The application layer module 305 may use either the location and network communications module 327 or its own communication model to send serialized profile data to external services subject to application, system and user privacy and security settings. In various embodiments, translators can then be used to map respective item ontologies of the external services to ontologies/items/concepts/schemas expressed in the profile data.

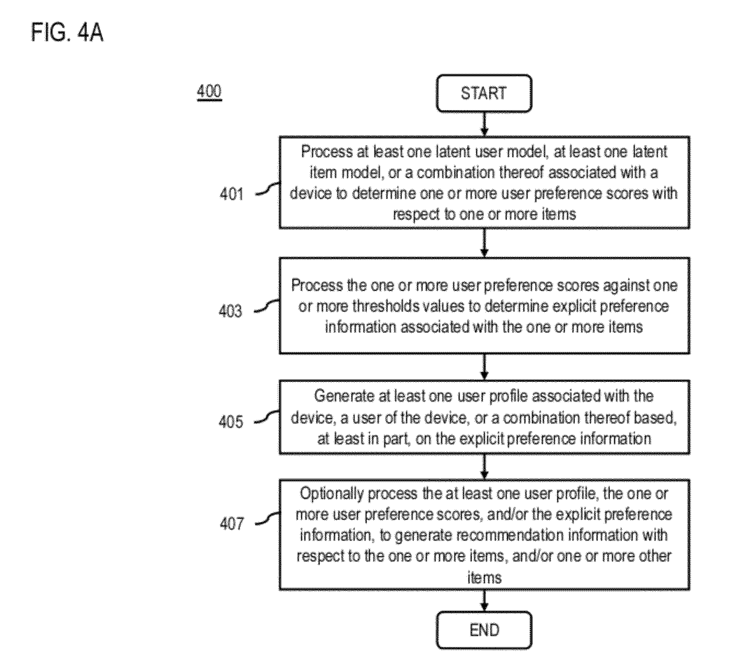

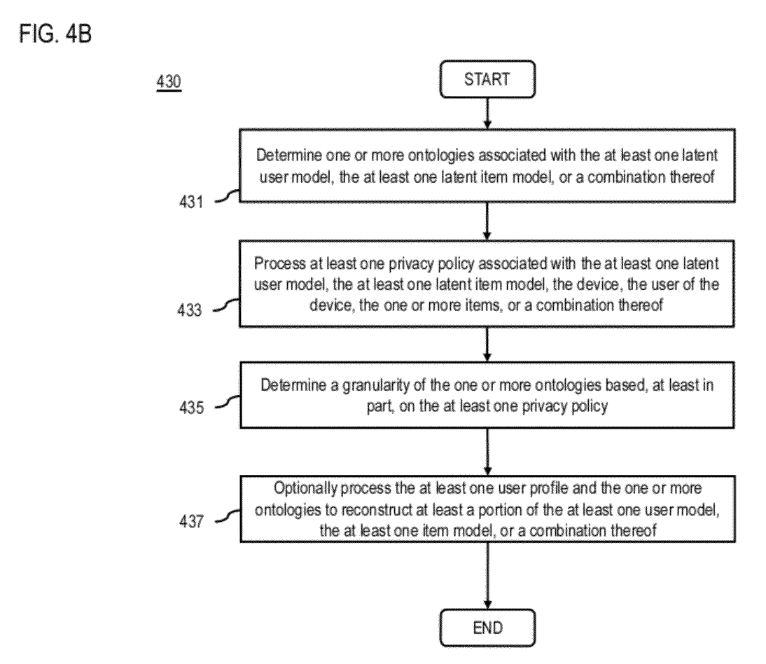

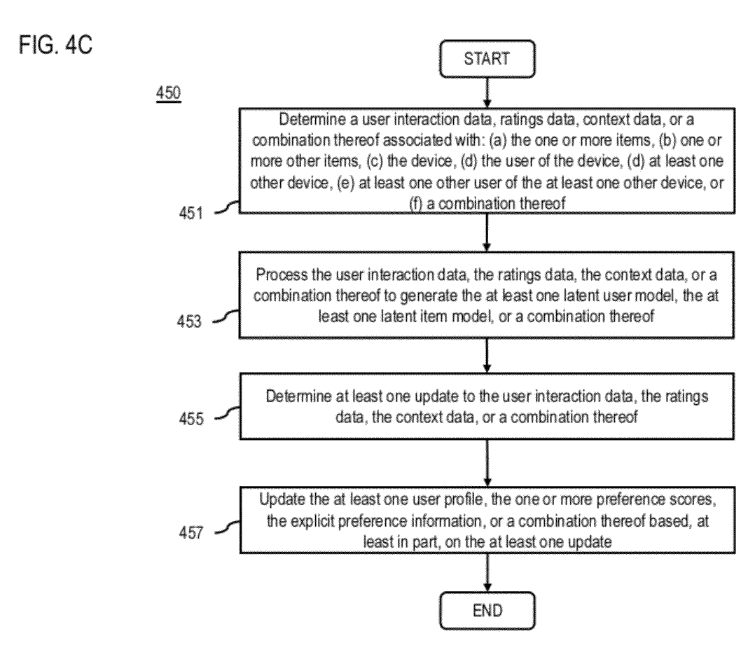

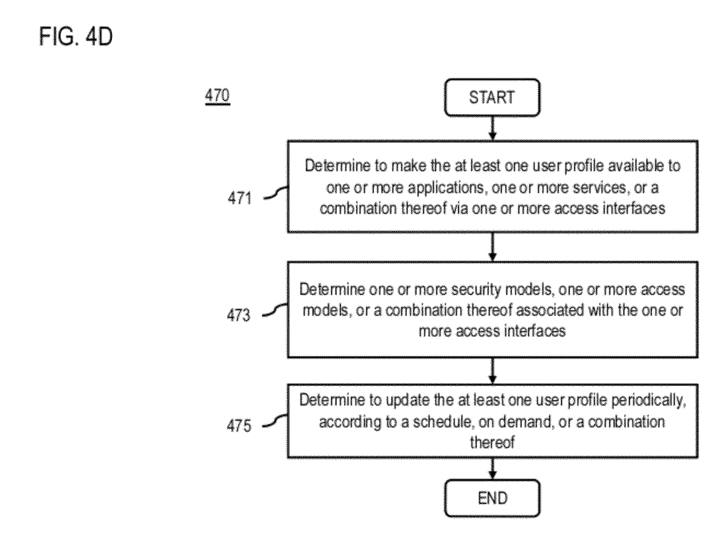

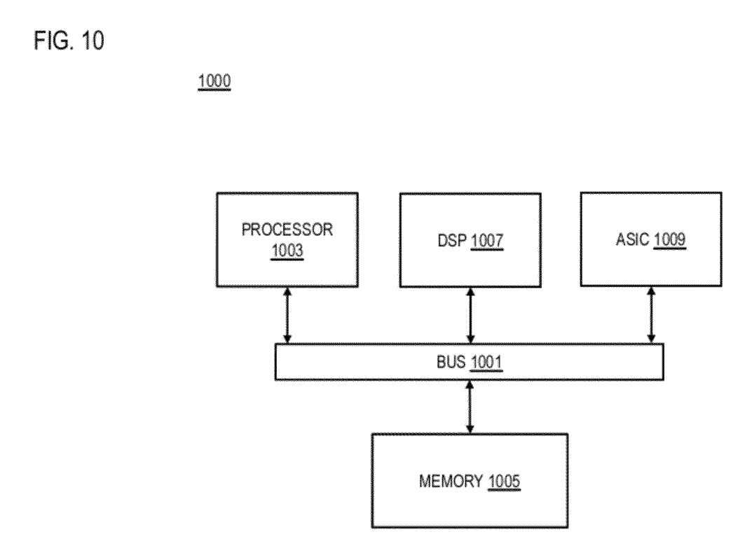

FIGS. 4A-4D are flowcharts of a process for providing recommendations based on preloaded models, according to one embodiment. FIG. 4A shows a process 400 for generating a user profile and recommendations at a device that is preloaded with a user model and/or an item model. In one embodiment, the model platform 103 performs the process 400 and is implemented in, for instance, a chip set including a processor and a memory as shown in FIG. 10. In step 401, the model platform 103 processes at least one latent user model, at least one latent item model, and a combination thereof associated with a device to determine one or more user preference scores with respect to one or more items. The latent user model may be acquired by preloading of the device (e.g. UE 101) with user models and an item model, or by setting a user preference. A user model may be quantitative data representing user specificities related to the items. Items may represent various features or settings, such as user interface modes, points of interest, useful tips and hints, etc. There may be ratings for the items, wherein the ratings are quantitative values. In one example, higher rating represents higher preference. The user model and the item model can be combined together to generate ratings or data related to ratings. Thus, if the user model and ratings data for the items are known, the item model may also be calculated based on the user model and the ratings data. In one embodiment, the user model and the item model are vectors, which may be a user profile vector (UPV) and an item profile vector (IPV), respectively. Further, the preloading may take place at a manufacturing stage of the device, before the device is delivered to the user. The user model and the item model that is preloaded at the device may be standard user model and the item model that are trained or created based on information about a large number of users. The latent user model or latent item model may also be modified on the user device, as discussed above, by changing preferences on the user device.

In step 403, the model platform 103 processes the one or more user preference scores (vector values in latent user model) against one or more thresholds values (mentioned in ontology) to determine explicit preference information associated with the one or more items. The model platform 103 may also cause collection of user interaction data, ratings data, context data, or a combination thereof, from the device. The user interaction data may include the user's internal usage data and the user's external usage data. The user's internal usage data may include data regarding the user's interaction within the device. This may include the user's usage of software applications (e.g. telephone, text messages, email application, a calendar, a media player, advertisements clicked), as well as the time and the location when the use took place. The external usage data may include data regarding the user's interaction with an external service or another device. For example, the user's usage of a picture sharing website (e.g. downloading and uploading pictures at the website) or the user's usage of a social networking service may be recorded as the external usage data. The ratings data may represent ratings of the items. The ratings data may be collected by requesting the user to participate in the rating. The rating may be in a number scale (e.g. a scale of one through ten) or in a like/dislike button format. The context data may include data from a sensor such as a location sensor, a speed sensor, an audio sensor, a brightness sensor, etc. The context data may also include user profile information as well as the user calendar information. The user interaction data and the context data may be used to form the user model.

Also in step 405, this data collected at the device (e.g. UE 101) may be processed to generate a user model for the device. The user model may be generated into at least one user profile associated with the device, a user of the device or combination thereof based on the explicit preference information determined in step 403. If the user model is preloaded at the device or the user model already exists in the device, then this data may be processed to customize the existing user model. In one example, a plurality of user models may be available for the preloading, as well as their item models, and one user model may be randomly selected and may be preloaded at the device. Over a period of time, the device collects the data, and customizes the initially selected user model based on the collected data. This customized user model may be compared with other user models from the set of the plurality of user models, and then a user model that matches the customized user model closely may be loaded at the device. This process may be repeated to provide the most up-to-date user model for the user.

Then, in step 407, the model platform 103 causes optional processing of the at least one user profile, the one or more user preference scores, and/or the explicit preference information, to generate recommendation information with respect to the one or more items, and/or one or more other items. In one embodiment, the processing may be based, at least in part, on use of translators that contain ontologies for mapping the concepts expressed in the profile, preference scores, and/or explicit preference information to the one or more items and/or the one or more other items. In this step, because the user model and the item model are combined to result in ratings data, the user model and the item model may be processed to create the ratings data. The ratings data may be used to generate recommendations. The items showing high ratings are generally recommended. Thus, for example, if a tourist's points of interest show high ratings while a professor's points of interest show low ratings, a map on the device may display the tourist's points of interest, showing popular tourist destinations on the map.

In one embodiment, the model platform 103 may determine a new application, a new capability, a new item, new context data, or a combination thereof, associated with the device and/or the user, and then may cause an update to the user model and/or the item model, based on this information. For example, if the device downloads a new application or update the device software for new capability and new items, or a new context data is available at the device, then the existing user model and/or item model may not reflect these new features. Therefore, it may be helpful to update the user model and/or the item model according to these new features. The update to the user model and/or the item model may be performed periodically, according to a schedule, on demand, or a combination thereof. In addition, the update may be based, at least in part, on translators to map the ontologies of the new application, items, context data, etc. to the user model and/or the item model.

In another embodiment, the model platform 103 causes a transfer of the user model and/or the item model to another device associated with the user. This may be performed if the user wants to maintain the same user experience by keeping the same user model and/or item model when switching to another device. This transfer may also be performed via an external service. For example, the user model and/or the item model may first be transferred from the originating device to the service, and then can be downloaded to another device from the service.

FIG. 4B shows a process 430 of determining one or more ontologies associated with the at least one latent user model, according to one embodiment. In one embodiment, the model platform 103 performs the process 430 and is implemented in, for instance, a chip set including a processor and a memory as shown in FIG. 10. In step 431, the model platform 103 determines one or more ontologies associated with the at least one latent user model, the at least one latent item model, or a combination thereof. The process continues to step 433 in which the model platform 103 processes at least one privacy policy associated with the at least one latent user model, the at least one latent item model, the device, the user of the device, the one or more items, or a combination thereof. Next, in step 435, the model platform 103 determines a granularity of the one or more ontologies based, at least in part, on the at least one privacy policy. For example, the granularity may be how particular information available in the ontology may be accessed based on a privacy policy set by a user in a preferences interface of the user profile. Next, the process optionally continues to step 437 in which the model platform 103 processes the at least one user profile and the one or more ontologies to reconstruct at least a portion of the at least one user model, the at least one item model, or a combination thereof. For example, if it is desirable to reverse engineer the original user model or item model, these models may be backed into by way of the user profile, available ontology information, and/or one or more translators for mapping the ontology information to the items/concepts in the explicit representation schema of the user profile.

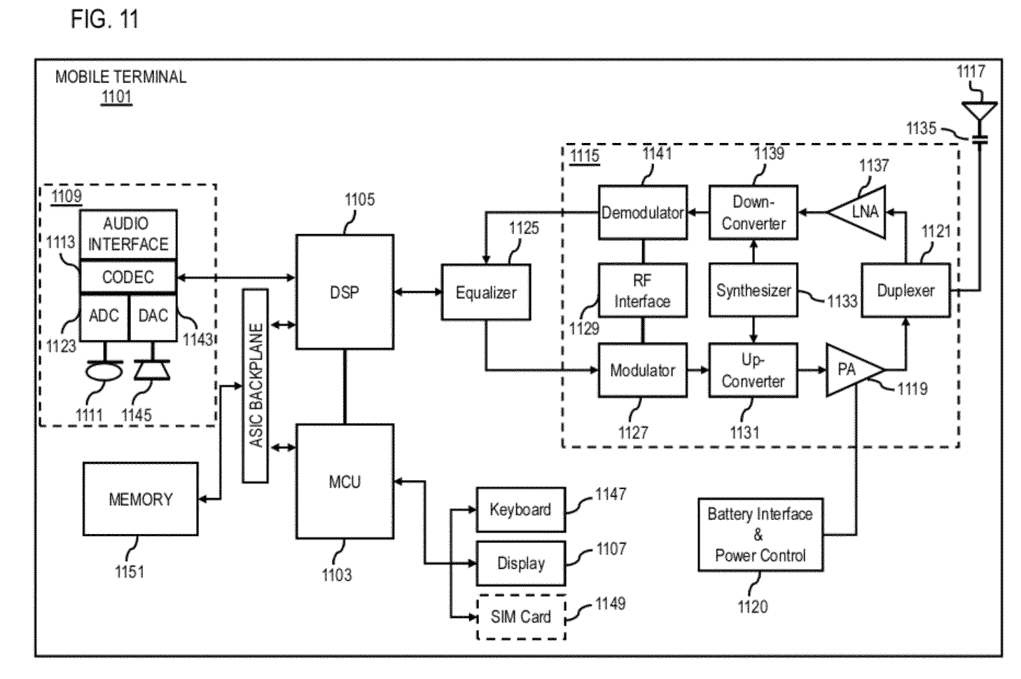

FIG. 4C shows a process 450 of determining user data and updating the at least one user profile, according to one embodiment. In one embodiment, the model platform 103 performs the process 450 and is implemented in, for instance, a chip set including a processor and a memory as shown in FIG. 11. In step 451, the model platform 103 determines a user interaction data, ratings data, context data, or a combination thereof associated with: (a) the one or more items, (b) one or more other items, (c) the device, (d) the user of the device, (d) at least one other device, (e) at least one other user of the at least one other device, or (f) a combination thereof. The process continues to step 453 in which the model platform 103 processes the user interaction data, the ratings data, the context data, or a combination thereof to generate the at least one latent user model, the at least one latent item model, or a combination thereof. Next, in step 455, the model platform 103 determines at least one update to the user interaction data, the ratings data, the context data, or a combination thereof. Then, in step 457, the model platform 103 updates the at least one user profile, the one or more preference scores, the explicit preference information, or a combination thereof based, at least in part, on the at least one update.

FIG. 4D shows a process 470 of determining to make the at least one user profile available to one or more applications or services, according to one embodiment. In one embodiment, the model platform 103 performs the process 470 and is implemented in, for instance, a chip set including a processor and a memory as shown in FIG. 10. In step 471, the model platform 103 determines to make the at least one user profile available to one or more applications, one or more services, or a combination thereof via one or more access interfaces. Next, in step 473, the model platform 103 determines one or more security models, one or more access models, or a combination thereof associated with the one or more access interfaces. For example, a user may prefer to limit certain services or applications for having access or being able to use the user's user profile. Then, in step 475, the model platform 103 determines to update the at least one user profile periodically, according to a schedule, on demand, or a combination thereof. Such a determination may be made based on user selected preferences or based on a preloaded model that has defaults for updating the user profile that may be accessible by applications and services.

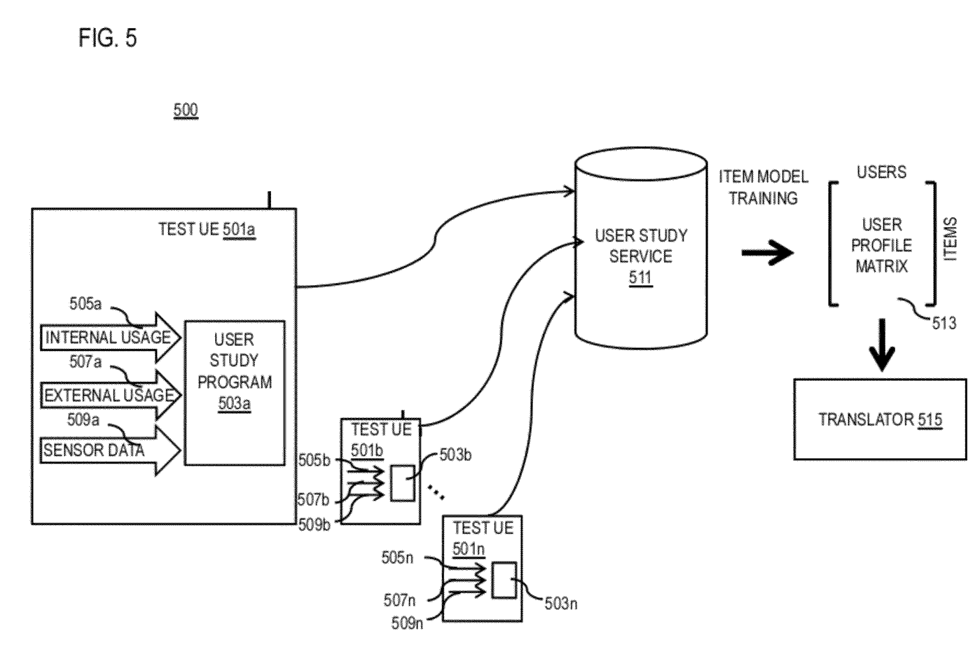

FIGS. 5 is a diagram of interactions utilized in the processes of FIGS. 4A-4D, according to one embodiment. This diagram 500 shows how the user model and the item model are generated such that the item model can be pre-loaded to a user device and a user profile matrix 513 may be generated. This may take place during a user study when data is collected from devices of prototypical users or test users. The test UEs 501a-501n may use a user study program application 503a-503n to collect data including the internal usage data 505a-505n, the external usage data 507a-507n and the sensor data 509a-509n, respectively. The internal usage data, the external usage data, and the sensor data may include information about the items that can be offered to the user. The internal usage data may include data showing which software applications are used, and when and where the applications are used. The external usage data may include data regarding usage of devices or services outside the device, and thus may include usage of internet services (e.g. browsing social networking site, downloading music from media download site etc.). The sensor data may include data collected via a sensor connected to the test UE 501, wherein the sensors may include a location sensor (e.g. GPS), accelerometer, gyroscope/compass, audio sensor), and may also include context data based on the sensors, such as staying at home or at office (determined based on the location device, for example. The data collected at the test UEs 501a-501n may be sent to the user study service 511 such that the user study service 511 may compute the user models. The user models may be vectors with quantitative values. Alternatively, the user models may be computed at the respective test UEs 501a-501n based on their respective data, and then may be sent to the user study service 511. The user study service 511 may also collect ratings data from the test UEs 501a-501n corresponding to the items. Then, based on the computed user models and the ratings data for the items, an item model is computed. Because the user profile data 513 is based on a combination of the item model and the user model, the item model may be computed based on the user model of the test users and their ratings data. The user model and the item model then can be preloaded to a user device, when the user first starts using the user device. Then, the user device may collect its own data, determine its own user model, and then using the item model, derive ratings and generate user profiles for the items or applications at the user device, in one embodiment. As previously noted, the derivation of the ratings and generation of the user profiles can be based, at least in part, on a translator 515. By way of example, the translator 515 including ontologies for mapping the schema of the user profiles to the respective items or applications.

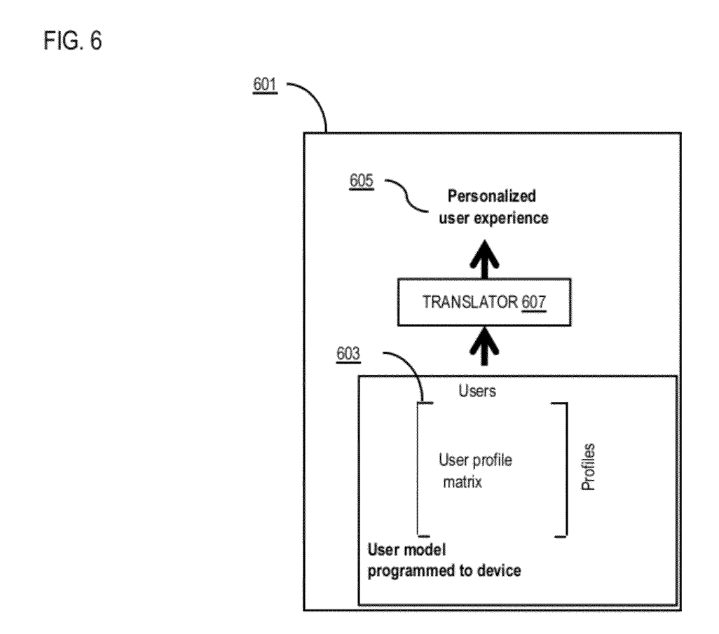

FIG. 6 is a diagram of a UE 601 illustrating how a user profile matrix 603 may result in a personalized user experience 605, according to one embodiment. For example, a user may develop a user profile as discussed above in FIG. 5. The user profile may be shared or saved among other user profiles that belong to the user or others, and based on rating and other factors, a recommendation may be made to the user of the UE 601 based on the user profile matrix 603 to develop a personalized experience 605. In one embodiment, the personalized experience 605 is based, at least in part, on the translator 607 performing a mapping of the representation schema for item or concept preferences expressed in the profile matrix 603 to one or more ontologies for making the recommendation to generate the personalized experience 605. For instance, a plurality of users have all rated a particular application as being helpful for running a user device. If the user has certain preference settings, the user may match with other user profiles (e.g., via the translator 607) and the recommendation may be made to the user to personalize the user's UE 601 in a manner like other users.

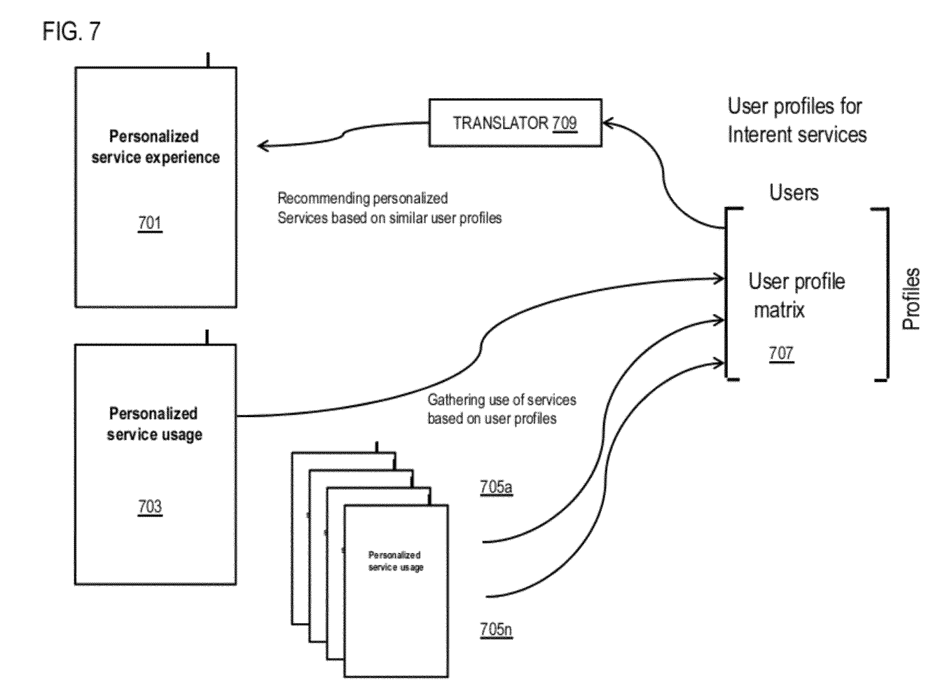

FIG. 7 is a diagram illustrating the process described in FIG. 6, according to one embodiment. A user of UE 701, in this embodiment, experiences, or requests, a personalized service experience on UE 701. The experience is based on user profile data from other users of UE 703, 705a-705n, and even the user profile of UE 701 himself. The user profile is submitted to a service and stored in a user profile matrix 707. The user profiles in the user profile matrix 707 are then matched with the user's preferences and own user profile (e.g., via one or more ontologies of the translator 709) to determine recommendations that should be made to the user to develop a personalized service experience 701. The personalized service experience 701 is then sent to the UE 101 from the user profile matrix 707 which may be stored and processed by the model platform 103.

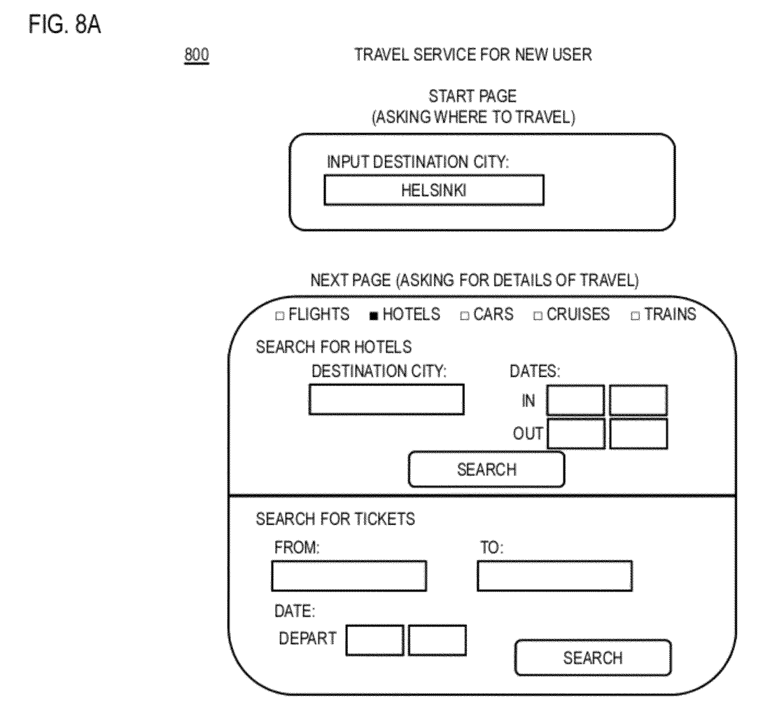

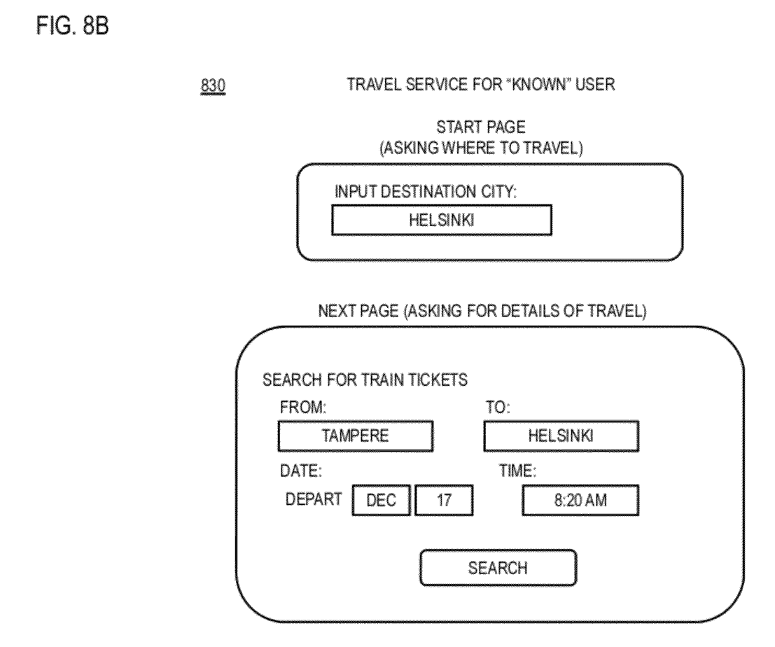

FIGS. 8A and 8B are illustrations, according to one embodiment, of how a user profile may affect a user's service experience if the user's privacy setting so allow. For example, a user visits a website searching for travel plans for a particular location. In this example, the user has selected Helsinki In FIG. 8A, the user has not shared his user profile so no information about the user is available to personalize the user's service experience on the website 800. Or, the service illustrated in 8A does not know any information about the user because the user is new to the service. As such, the user's interactions with the website may be stored for later use so that the user's experience may be personalized.

FIG. 8B illustrates a user experience on a website 830 for travel if the user is known. Here, the user may have done booking before, or the user may have shared his user profile with the service. Because this information is known, the service knows the current context of the user (i.e. location and time), and also knows when the user typically books travel to Helsinki. Because the user typically takes a train to Helsinki, based on the user profile, the service may suggest taking a train to Helsinki and automatically populate the page for the user instead of asking the user to populate fields, or suggesting flights, for example.

The processes described herein for providing recommendations based on preloaded models may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

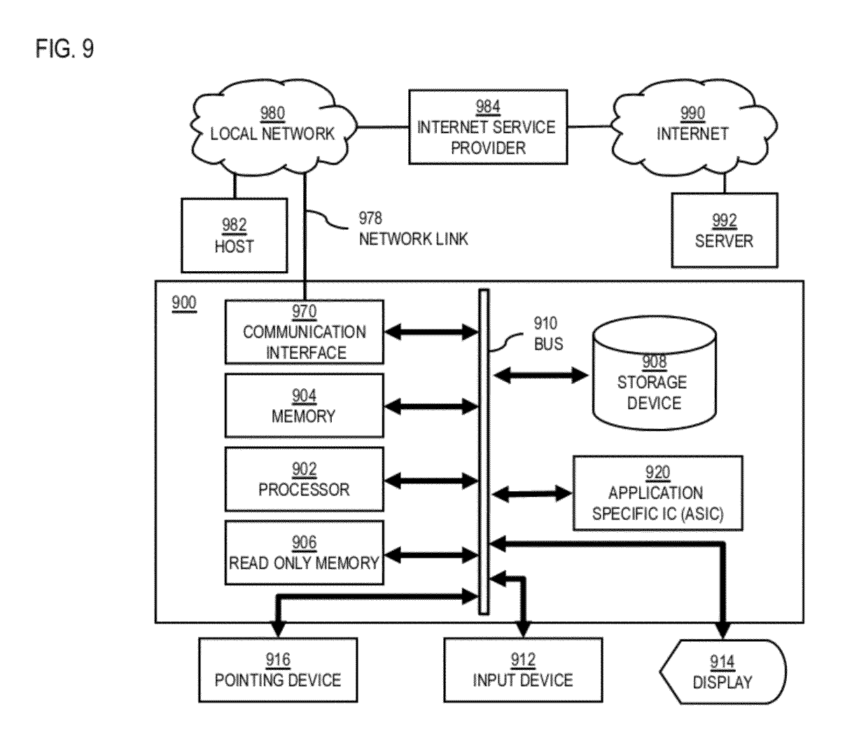

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide recommendations based on preloaded models and generate user profiles as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing recommendations based on preloaded models and for generating user profiles.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing recommendations based on preloaded models and for generating user profiles. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for providing recommendations based on preloaded models and for generating user profiles. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing recommendations based on preloaded models and for generating user profiles, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for providing recommendations based on preloaded models and for generating user profiles to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to provide recommendations based on preloaded models and generate user profiles as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing recommendations based on preloaded models and for generating user profiles.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide recommendations based on preloaded models and generate user profiles. The memory 1005 also stores the data associated with or generated by the execution of the inventive steps.

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of providing recommendations based on preloaded models and for generating user profiles. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing recommendations based on preloaded models and for generating user profiles. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide recommendations based on preloaded models and generate user profiles. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a processing of at least one latent user model, at least one latent item model, or a combination thereof associated with a device to determine one or more user preference scores with respect to one or more items;
a processing of the one or more user preference scores against one or more thresholds values to determine explicit preference information associated with the one or more items; and
a generation of at least one user profile associated with the device, a user of the device, or a combination thereof based, at least in part, on the explicit preference information.

2. A method of claim 1, wherein the (1) data and/or (2) information and/or (3) at least one signal are further based, at least in part, on the following:
a processing of the at least one user profile, the one or more user preference scores, the explicit preference information, or a combination thereof to generate recommendation information with respect to the one or more items, one or more other items, or a combination thereof.

3. A method of claim 2, wherein the (1) data and/or (2) information and/or (3) at least one signal are further based, at least in part, on the following:
a determination of one or more ontologies associated with the at least one latent user model, the at least one latent item model, or a combination thereof,
wherein the at least one user profile, the one or more user preference scores, the explicit preference information, or a combination thereof is based, at least in part, on the one or more ontologies.

4. A method of claim 3, wherein the (1) data and/or (2) information and/or (3) at least one signal are further based, at least in part, on the following:
a processing of at least one privacy policy associated with the at least one latent user model, the at least one latent item model, the device, the user of the device, the one or more items, or a combination thereof; and
a determination of a granularity of the one or more ontologies based, at least in part, on the at least one privacy policy.

5. A method of claim 3, wherein the (1) data and/or (2) information and/or (3) at least one signal are further based, at least in part, on the following:
a processing of the at least one user profile and the one or more ontologies to reconstruct at least a portion of the at least one user model, the at least one item model, or a combination thereof.

6. A method of claim 1, wherein the at least one user model is preloaded at the device, and wherein the (1) data and/or (2) information and/or (3) at least one signal are further based, at least in part, on the following:
a determination of a user interaction data, ratings data, context data, or a combination thereof associated with: (a) the one or more items, (b) one or more other items, (c) the device, (d) the user of the device, (d) at least one other device, (e) at least one other user of the at least one other device, or (f) a combination thereof; and
a processing of the user interaction data, the ratings data, the context data, or a combination thereof to generate the at least one latent user model, the at least one latent item model, or a combination thereof.

7. A method of claim 6, wherein the at least one user model is preloaded at the device, and wherein the (1) data and/or (2) information and/or (3) at least one signal are further based, at least in part, on the following:
a determination of at least one update to the user interaction data, the ratings data, the context data, or a combination thereof; and
an updating of the at least one user profile, the one or more preference scores, the explicit preference information, or a combination thereof based, at least in part, on the at least one update.

8. A method of claim 1, wherein the at least one user model is preloaded at the device, and wherein the (1) data and/or (2) information and/or (3) at least one signal are further based, at least in part, on the following:
a determination to make the at least one user profile available to one or more applications, one or more services, or a combination thereof via one or more access interfaces.

9. A method of claim 8, wherein the (1) data and/or (2) information and/or (3) at least one signal are further based, at least in part, on the following:
a determination of one or more security models, one or more access models, or a combination thereof associated with the one or more access interfaces,
wherein the at least one user profile is made available according to the one or more security model, the one or more access models, or a combination thereof.

10. A method of claim 1, wherein the (1) data and/or (2) information and/or (3) at least one signal are further based, at least in part, on the following:
determining to update the at least one user profile periodically, according to a schedule, on demand, or a combination thereof.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing at least one latent user model, at least one latent item model, or a combination thereof associated with a device to determine one or more user preference scores with respect to one or more items;
process and/or facilitate a processing of the one or more user preference scores against one or more thresholds values to determine explicit preference information associated with the one or more items; and
cause, at least in part, a generation of at least one user profile associated with the device, a user of the device, or a combination thereof based, at least in part, on the explicit preference information.

12. An apparatus of claim 11, wherein the apparatus is further caused to:
process and/or facilitate a processing of the at least one user profile, the one or more user preference scores, the explicit preference information, or a combination thereof to generate recommendation information with respect to the one or more items, one or more other items, or a combination thereof.

13. An apparatus of claim 12, wherein the apparatus is further caused to:
determine one or more ontologies associated with the at least one latent user model, the at least one latent item model, or a combination thereof,
wherein the at least one user profile, the one or more user preference scores, the explicit preference information, or a combination thereof is based, at least in part, on the one or more ontologies.

14. An apparatus of claim 13, wherein the apparatus is further caused to:
process and/or facilitate a processing of at least one privacy policy associated with the at least one latent user model, the at least one latent item model, the device, the user of the device, the one or more items, or a combination thereof; and
determine a granularity of the one or more ontologies based, at least in part, on the at least one privacy policy.

15. An apparatus of claim 13, wherein the apparatus is further caused to:
process and/or facilitate a processing of the at least one user profile and the one or more ontologies to reconstruct at least a portion of the at least one user model, the at least one item model, or a combination thereof.

16. An apparatus of claim 11, wherein the apparatus is further caused to:
determine user interaction data, ratings data, context data, or a combination thereof associated with: (a) the one or more items, (b) one or more other items, (c) the device, (d) the user of the device, (d) at least one other device, (e) at least one other user of the at least one other device, or (f) a combination thereof; and
process and/or facilitate a processing of the user interaction data, the ratings data, the context data, or a combination thereof to generate the at least one latent user model, the at least one latent item model, or a combination thereof.

17. An apparatus of claim 16, wherein the apparatus is further caused to:
determine at least one update to the user interaction data, the ratings data, the context data, or a combination thereof; and
cause, at least in part, an updating of the at least one user profile, the one or more preference scores, the explicit preference information, or a combination thereof based, at least in part, on the at least one update.

18. An apparatus of claim 11, wherein the apparatus is further caused to:
determine to make the at least one user profile available to one or more applications, one or more services, or a combination thereof via one or more access interfaces.

19. An apparatus of claim 18, wherein the apparatus is further caused to:
determine one or more security models, one or more access models, or a combination thereof associated with the one or more access interfaces,
wherein the at least one user profile is made available according to the one or more security model, the one or more access models, or a combination thereof.

20. An apparatus of claim 11, wherein the apparatus is further caused to:
determine to update the at least one user profile periodically, according to a schedule, on demand, or a combination thereof.
